(19) United States
(12) Patent Application Publication
(10) Pub. No.: US 2023/0174298 A1
(43) Pub. Date: Jun. 8, 2023

(54) Portable Trash Bag Holder Device

(71) Applicant: Michael Rickli, Kingwood, TX (US)

(72) Inventor: Michael Rickli, Kingwood, TX (US)

(21) Appl. No.: 18/051,567

(22) Filed: Nov. 1, 2022

Related U.S. Application Data
(60) Provisional application No. 63/286,607, filed on Dec. 7, 2021.

(51) Int. Cl. B65F 1/14

(52) U.S. Cl. CPC B65F 1/1415

(57) ABSTRACT

The present invention relates to a portable trash bag holder device primarily comprised of a bracket that is further comprised of a top surface, a bottom surface, a rear surface, at least one pair of side surfaces, and a front surface. In addition, the device is comprised of an outer ring and an inner ring. A trash bag or other bag of the like can be placed within the outer ring, wherein the inner ring can then be placed within the outer ring to secure the bag between both rings and suspend the bag from the device in an opened position. The bracket can further be secured to an object via a strap with a ratchet assembly or by the use of at least one fastener. Therefore, the device can be positioned and used in a plurality of locations and does not require an even ground surface.

### CROSS-REFERENCE TO RELATED APPLICATION

The present application claims priority to, and the benefit of, U.S. Provisional Application No. 63/286,607, which was filed on Dec. 7, 2021, and is incorporated herein by reference in its entirety.

### FIELD OF THE INVENTION

The present invention relates generally to the field of trash bags. More specifically, the present invention relates to a portable trash bag holder device. The device is primarily comprised of a bracket that is further comprised of a top surface, a bottom surface, a rear surface, at least one pair of side surfaces, and a front surface. The device is further comprised of an outer ring and an inner ring. A trash bag or other bag of the like can be placed within the outer ring, wherein the inner ring can then be placed within the outer ring to secure the bag between both rings and suspend the bag from the device in an opened position. The bracket can further be secured to an object via a strap with a ratchet assembly or by the use of at least one fastener. Therefore, the device can be positioned and used in a plurality of locations and does not require an even ground surface. Accordingly, the present disclosure makes specific reference thereto. Nonetheless, it is to be appreciated that aspects of the present invention are also equally applicable to other like applications, devices and methods of manufacture.

### BACKGROUND

Various commercial, industrial, and residential tasks and jobs involve cleaning up trash that may be created during the course of the task or job. Said trash is typically collected within a trash bag. In one instance, a user may hold a trash bag in one hand and walk around a job site or other area while picking up trash with their other hand and placing said trash into the bag. However, this may be undesirable, especially if the trash is extremely heavy and the user does not possess sufficient strength to hold the trash bag with the heavy trash inside. As a result, a user may keep the trash bag at a stationary location. But, the bag must still be manually opened when trash is being placed into the bag, which is inefficient and annoying. Therefore, a user may opt to place a trash bag within a trash can or other similar receptacle of the like. However, a trash can may not be able to be used if the task or job is located at an area with an uneven ground surface that a trash can cannot balance on.

Therefore, there exists a long-felt need in the art for an improved means of holding a trash bag. There also exists a long-felt need in the art for a portable trash bag holder device that does not require a user to hold a trash bag while using the bag to collect trash. Further, there exists a long-felt need in the art for a portable trash bag holder device that does not require a user to hold a trash bag while using the bag to collect trash, wherein the device also does not require that a user hold the bag open every time they wish to dump trash into the bag. In addition, there exists a long-felt need in the art for a portable trash bag holder device that can be used in locations without even ground surfaces or other areas where trash cans cannot be used. Finally, there exists a long-felt need in the art for a portable trash bag holder device that is extremely portable and can be used in a plurality of differing environments.

The subject matter disclosed and claimed herein, in one embodiment thereof, comprises a portable trash bag holder device. The device is primarily comprised of a bracket that is further comprised of a top surface, a bottom surface, a rear surface, at least one pair of side surfaces, and a front surface. In addition, the device is comprised of an outer ring and an inner ring. A trash bag or other bag of the like can be placed within the outer ring, wherein the inner ring can then be placed within the outer ring to secure the bag between both rings and suspend the bag from the device in an opened position. The bracket can further be secured to an object via a strap with a ratchet assembly or by the use of at least one fastener. Therefore, the device can be positioned and used in a plurality of locations and does not require an even ground surface.

In this manner, the portable trash bag holder device of the present invention accomplishes all of the forgoing objectives and provides an improved means of holding a trash bag. In doing so, the device does not require a user to hold a trash bag while using the bag to collect trash, nor does it require that a user hold the bag open every time they wish to dump trash into the bag. In addition, the device can be used in locations without even ground surfaces or other areas where trash cans cannot be used. Further, the device is extremely portable and can be used in a plurality of differing environments.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable trash bag holder device. The device is primarily comprised of a bracket that is further comprised of a top surface, a bottom surface, a rear surface, at least one pair of side surfaces, and a front surface. The device is also comprised of an outer ring and an inner ring. The bracket is preferably manufactured from a durable metal or rigid plastic that may have a plurality of indicia such as, but not limited to: patterns, logos, emblems, images, symbols, designs, letters, words, characters, animals, advertisements, brands, etc. The bracket may also be any color known in the art and may be transparent, semi-transparent, or opaque.

In one embodiment, the outer ring may attach to the front surface and/or top surface via at least one hinge. The hinge allows the outer ring to articulate in a 180-degree range of motion such that it can be folded (i.e., parallel with the rear surface) for storage and/or transport. The outer ring is further comprised of a removable inner ring. The inner ring is further comprised of a side surface and a top surface that together form a generally L-shaped lip. The top surface of the inner ring further removably rests on the top surface of the outer ring such that the inner ring can be removed from the outer ring by grabbing the top surface and/or pushing the inner ring upwards. The inner ring further has a gap that connects both sides of the inner ring by at least one spring, wherein the spring may be any springe-type known in the art.

The inner ring is used to secure at least one trash bag or other bag of the like within the outer ring such that the bag is suspended from the outer ring. To do so, a bag is first placed within the outer ring and folded over the top surface of the outer ring. Then, the inner ring can be pressed together slightly to create a compression force in the spring and can be placed within the outer ring and released such that a tension force is created in the spring which presses the inner ring against the outer ring and thus retains the inner ring within the outer ring. As a result, the bag is then secured between the inner ring and outer ring such that it is preferably suspended above a ground surface and secured within the device.

In one embodiment, the rear surface of the bracket is further comprised of at least one continuous opening that can receive at least one fastener such as, but not limited to: a nail, a screw, a bolt, etc. that allows the bracket to be screwed or fastened into an object such as, but not limited to: a portion of a structure, a tree, a wall, a machine, etc. In one embodiment, the fastener may be located on the rear surface. Each side surface may further be comprised of a continuous opening that receives a strap that attaches to a locking, ratchet assembly that forms the strap into a loop. In this manner, the strap can be used to secure the bracket around any object such as, but not limited to a tree.

Accordingly, the portable trash bag holder device of the present invention is particularly advantageous as it provides improved means of holding a trash bag that does not require a user to hold the trash bag while using the bag to collect trash. Further, the device also does not require that a user hold the bag open every time they wish to dump trash into the bag. In addition, the device can be used in locations without even ground surfaces or other areas where trash cans cannot be used, and is also extremely portable and can be used in a plurality of differing environments. In this manner, the portable trash bag holder device overcomes the limitations of existing methods of collecting trash and holding trash bags known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a portable trash bag holder device of the present invention in accordance with the disclosed architecture;

FIG. 2 illustrates an exploded view of one potential embodiment of a portable trash bag holder device of the present invention in accordance with the disclosed architecture;

FIG. 3 illustrates an enhanced perspective view of one potential embodiment of a portable trash bag holder device of the present invention in accordance with the disclosed architecture;

FIG. 4 illustrates multiple perspective views of one potential embodiment of a portable trash bag holder device of the present invention in accordance with the disclosed architecture; and

FIG. 5 illustrates a perspective view of one potential embodiment of a portable trash bag holder device of the present invention while attached around an object in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved means of holding a trash bag. There also exists a long-felt need in the art for a portable trash bag holder device that does not require a user to hold a trash bag while using the bag to collect trash. Further, there exists a long-felt need in the art for a portable trash bag holder device that does not require a user to hold a trash bag while using the bag to collect trash, wherein the device also does not require that a user hold the bag open every time they wish to dump trash into the bag. In addition, there exists a long-felt need in the art for a portable trash bag holder device that can be used in locations without even ground surfaces or other areas where trash cans cannot be used. Finally, there exists a long-felt need in the art for a portable trash bag holder device that is extremely portable and can be used in a plurality of differing environments.

The present invention, in one exemplary embodiment, is comprised of a portable trash bag holder device primarily comprised of a bracket that is further comprised of a top surface, a bottom surface, a rear surface, at least one pair of side surfaces, and a front surface further comprised of an outer ring and an inner ring. A trash bag or other bag of the like can be placed within the outer ring, wherein the inner ring can then be placed within the outer ring to secure the bag between both rings and suspend the bag from the device in an opened position. The bracket can further be secured to an object via a strap with a ratchet assembly or by the use of at least one fastener. Therefore, the device can be positioned and used in a plurality of locations and does not require an even ground surface.

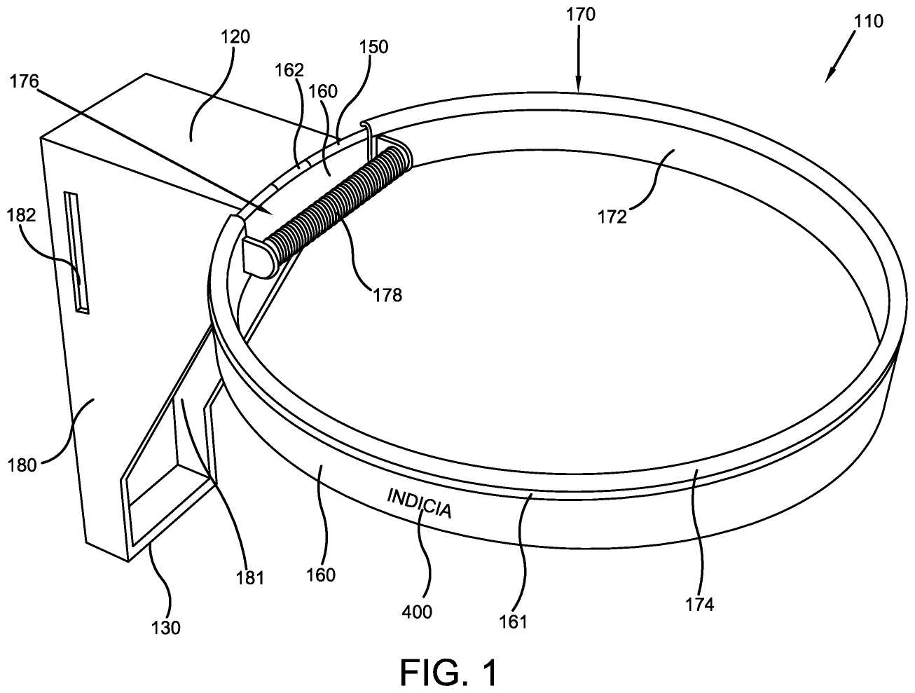

Referring initially to the drawings, FIG. 1 illustrates a perspective view of one potential embodiment of a portable trash bag holder device 100 of the present invention in accordance with the disclosed architecture. The device 100 is primarily comprised of a bracket 110 that is further comprised of a top surface 120, a bottom surface 130, a rear surface 140, at least one pair of side surfaces 180, and a front surface 150. In one embodiment, the outboard edge 181 of the side surface 180 is angled away from the rear surface 140 of the bracket 110. In this manner, the device 100 extends away from an object 10 that it is mounted on or attached to such that said object 10 does not obstruct the functionality of the device 100. The device is also comprised of an outer ring 160 and an inner ring 170. The bracket 110 is preferably manufactured from a durable metal such as, but not limited to: stainless steel or aluminum. However, the bracket 110 may also be manufactured from a rigid plastic such as, but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. Further, any surface of the bracket 110 or outer ring 160 may have a plurality of indicia 400 such as, but not limited to: patterns, logos, emblems, images, symbols, designs, letters, words, characters, animals, advertisements, brands, etc. The bracket 110 may also be any color known in the art and may be transparent, semi-transparent, or opaque.

It should be appreciated that in any embodiment of the device 100 the shape of the top surface 120, bottom surface 130, rear surface 140, side surfaces 180, and front surface 150 may be any shape known in the art. However, in the embodiment shown in the figures, the top surface 120 and rear surface 140 are generally rectangular, the side surfaces 180 are generally triangular and the front surface 150 is generally rectangular and is further comprised of a circular outer ring 160. In one embodiment, the outer ring 160 may attach to the front surface 150 and/or top surface 120 via at least one hinge 162. The hinge 162 may be any hinge-type known in the art such as, but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. In this manner, the outer ring 160 can articulate in a 180-degree range of motion such that it can be folded (i.e., parallel with the rear surface 140) for storage and/or transport.

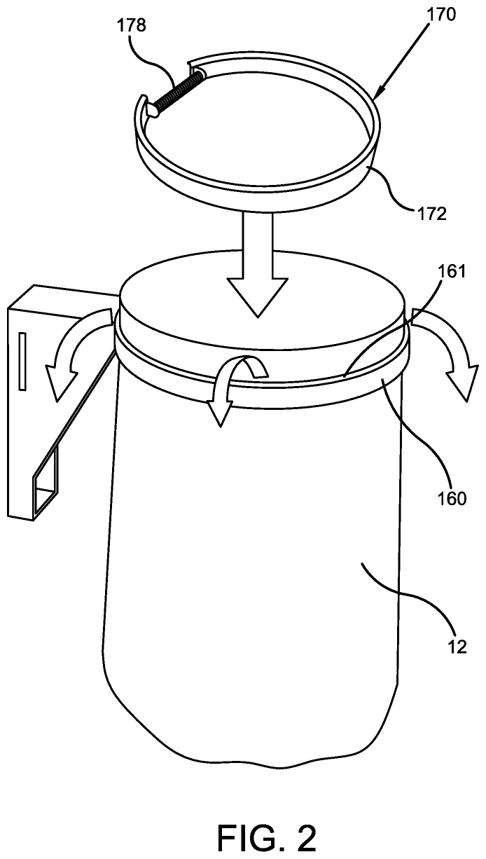

FIG. 2 illustrates an exploded view of one potential embodiment of a portable trash bag holder device 100 of the present invention in accordance with the disclosed architecture. The outer ring 160 is further comprised of a removable inner ring 170. The inner ring 170 is further comprised of a side surface 172 and a top surface 174 that together form a generally L-shaped lip. The top surface 174 of the inner ring 170 further removably rests on the top surface 161 of the outer ring 160 such that the inner ring 170 can be removed from the outer ring 160 by grabbing the top surface 174 and/or pushing the inner ring 170 upwards. Unlike the outer ring 160, the inner ring 170 is not a continuous circle. Instead, the inner ring 170 has a gap 176 that connects both sides of the inner ring 170 by at least one spring 178, wherein the spring 178 may be any springe-type known in the art.

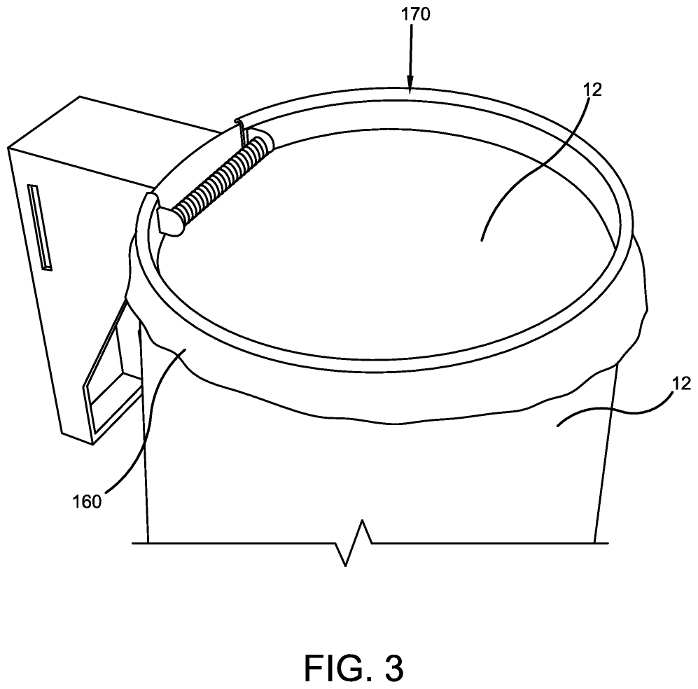

FIG. 3 illustrates an enhanced perspective view of one potential embodiment of a portable trash bag holder device 100 of the present invention in accordance with the disclosed architecture. The inner ring 170 is used to secure at least one trash bag 12 or other bag 12 of the like within the outer ring 160 such that the bag 12 is suspended from the outer ring 160. To do so, a bag 12 is first placed within the outer ring 160 and folded over the top surface 161 of the outer ring 160. Then, the inner ring 170 can be pressed together slightly to create a compression force in the spring 178. After being slightly pressed together, the inner ring 170 can be placed within the outer ring 160 and then released such that a tension force is created in the spring 178 which presses the inner ring 170 against the outer ring 160 and thus retains the inner ring 170 within the outer ring 160. As a result, the bag 12 is then secured between the inner ring 170 and outer ring 160 such that it is preferably suspended above a ground surface 20 and secured within the device 100. In a differing embodiment, both the inner ring 170 and outer ring 160 may be attached to one another via at least one fastener 300 such as, but not limited to: adhesive, magnet, tongue and groove, hook and loop, etc.

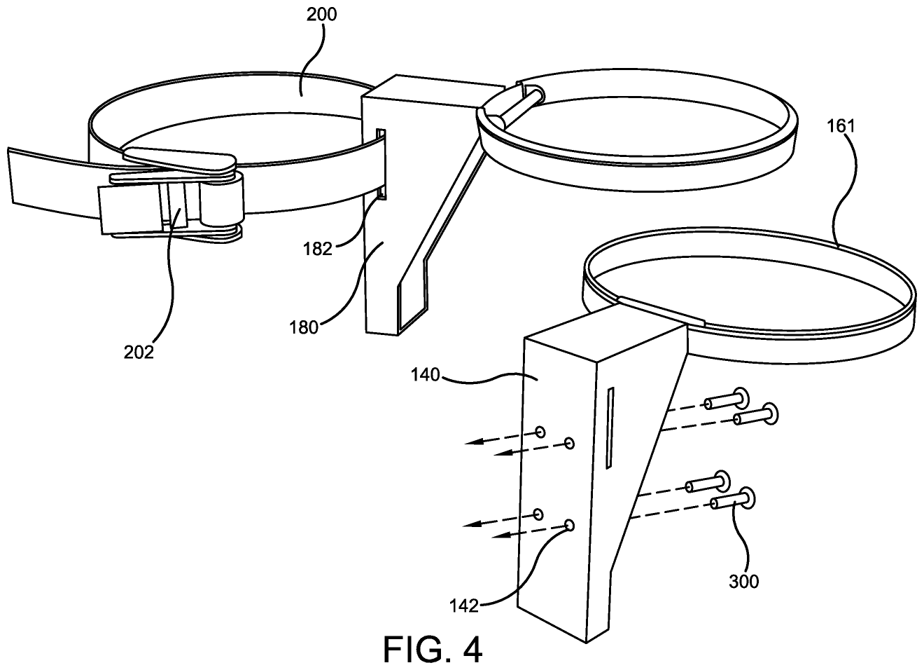

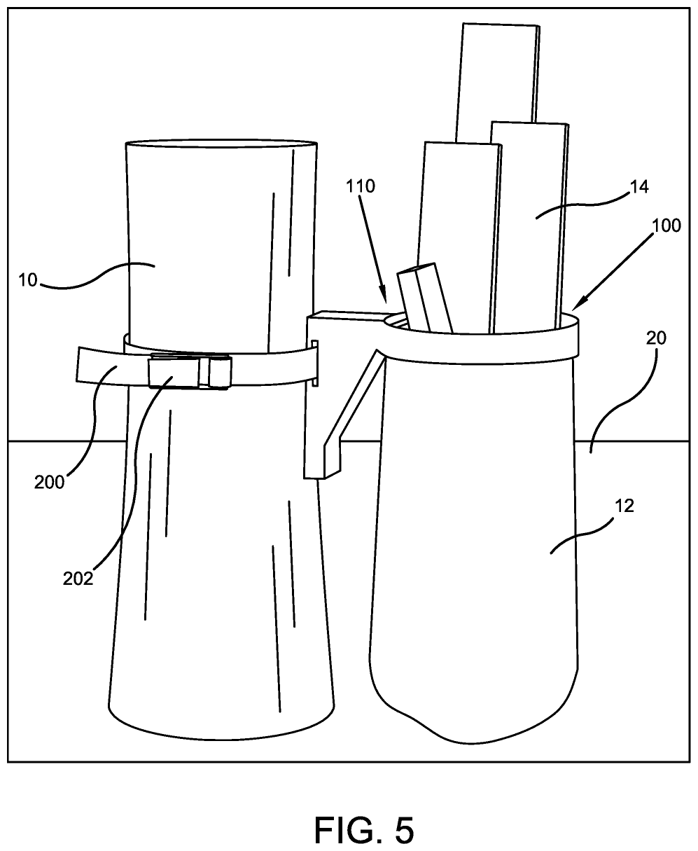

FIG. 4 illustrates multiple perspective views of one potential embodiment of a portable trash bag holder device 100 of the present invention in accordance with the disclosed architecture. During use, the device 100 can be attached around or secured to an object 10, as also seen in FIG. 5. In one embodiment, the rear surface 140 of the bracket 110 (or in a differing embodiment, any portion of the bracket 110) is further comprised of at least one continuous opening 142 that can receive at least one fastener 300 such as, but not limited to: a nail, a screw, a bolt, etc. that allows the bracket 110 to be screwed or fastened into an object 10 such as, but not limited to: a portion of a structure, a tree, a wall, a machine, etc. In one embodiment, the fastener 300 may be located on the rear surface 140 and may include, but is not limited to: an adhesive, a magnet, a suction cup, or any other non-permanent fastening means of the like. Each side surface 180 may further be comprised of a continuous opening 182 that receives a strap 200. The strap 200 is preferably manufactured from a durable material such as, but not limited to: polyester, polypropylene, dacron, etc. and attaches to a locking, ratchet assembly 202 that forms the strap 200 into a loop. In this manner, the strap 200 can be used to secure the bracket 110 around any object 10 such as, but not limited to a tree, as shown in FIG. 5.

In this manner, the device 100 can be used in any location where an object 10 exists that the device 100 can be strapped around or fastened to. As a result, the device 100 can be used in a large number of locations where a traditional trash can cannot be used due to uneven surfaces or space constraints. In addition, the inner ring 170 ensures a trash bag 12 cannot fall out of the outer ring 160 during use, thereby ensuring any trash 14 within the bag 12 cannot spill.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable trash bag holder device” and “device” are interchangeable and refer to the portable trash bag holder device 100 of the present invention.

Notwithstanding the forgoing, the portable trash bag holder device 100 of the present invention and its various components can be of any suitable size and configuration as is known in the art without affecting the overall concept of the invention, provided that they accomplish the above-stated objectives. One of ordinary skill in the art will appreciate that the size, configuration and material of the portable trash bag holder device 100 as shown in the FIGS. are for illustrative purposes only, and that many other sizes and shapes of the portable trash bag holder device 100 are well within the scope of the present disclosure. Although the dimensions of the portable trash bag holder device 100 are important design parameters for user convenience, the portable trash bag holder device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable trash bag holder device comprising:
a bracket;
an outer ring having a continuous opening therein;
an inner ring; and
a spring, wherein the inner ring is positioned at least partially within the continuous opening of the outer ring.

2. The portable trash bag holder device of claim 1, wherein the inner ring is repositionable relative to the outer ring.

3. The portable trash bag holder device of claim 1, wherein the inner ring is further comprised of a top portion and a side portion that forms a generally L-shaped lip.

4. The portable trash bag holder device of claim 3, wherein the generally L-shaped lip rests on a top surface of the outer ring.

5. The portable trash bag holder device of claim 1 further comprising a plurality of fasteners that are sized and configured to fit through a plurality of openings in a rear surface of the bracket for securing the portable trash bag holder device to an object.

6. The portable trash bag holder device of claim 1, wherein the spring creates a tension force and secures the inner ring to the outer ring.

7. The portable trash bag holder device of claim 1 further comprising a strap that is sized and configured to pass through an opening in a pair of side surfaces of the bracket and secure the portable trash bag holder device to an object.

8. The portable trash bag holder device of claim 7 further comprising a ratchet assembly for tightening or loosening the strap.

9. A portable trash bag holder device comprising:
a bracket;
an outer ring having a continuous opening therein, wherein the outer ring is attached to the bracket;
an inner ring positioned at least partially within the continuous opening of the outer ring; and
a trash bag having an upper lip that is positioned between the outer ring and the inner ring.

10. The portable trash bag holder device of claim 9, wherein the inner ring is further comprised of a top portion and a side portion that forms a generally L-shaped lip.

11. The portable trash bag holder device of claim 10, wherein the generally L-shaped lip rests on a top surface of the outer ring.

12. The portable trash bag holder device of claim 9 further comprising a spring and a plurality of fasteners, wherein each of the plurality of fasteners is sized and configured to fit through a select one of a plurality of openings in a rear surface of the bracket for securing the portable trash bag holder device to an object.

13. The portable trash bag holder device of claim 12, wherein the spring creates a tension force and secures the trash bag between the inner ring and the outer ring.

14. The portable trash bag holder device of claim 9 further comprising a strap that is sized and configured to pass through an opening in a pair of side surfaces of the bracket and secures the portable trash bag holder device to an object.

15. The portable trash bag holder device of claim 7 further comprising a ratchet assembly for tightening or loosening the strap.

16. A portable trash bag holder device comprising:
a bracket having a rear surface, a top surface, a plurality of side surfaces and a front surface;
an outer ring having a continuous opening therein, wherein the outer ring is attached to the front surface of the bracket;
an inner ring positioned at least partially within the continuous opening of the outer ring, wherein the inner ring comprises a lip and a gap;
a spring that both spans and is positioned adjacent to the gap; and
a trash bag having an upper lip that is positioned between the outer ring and the inner ring.

17. The portable trash bag holder device of claim 16 further comprising a plurality of fasteners, wherein each of the plurality of fasteners is sized and configured to fit through a select one of a plurality of openings in the rear surface of the bracket for securing the portable trash bag holder device to an object.

18. The portable trash bag holder device of claim 16, wherein each of the side surfaces have an outboard edge that is angled away from the rear surface.

19. The portable trash bag holder device of claim 16 further comprising a strap that is sized and configured to pass through an opening in the pair of side surfaces of the bracket and secures the portable trash bag holder device to an object.

20. The portable trash bag holder device of claim 19 further comprising a ratchet assembly for tightening or loosening the strap.
